(19) United States
(12) Patent Application Publication
(10) Pub. No.: US 2011/0155400 A1
(43) Pub. Date: Jun. 30, 2011

(54) FIRE EXTINGUISHING WITH HELICOPTERS BY MEANS OF THE RAINSTORM METHOD

(76) Inventor: Moshos Karagounis, Athens (GR)

(21) Appl. No.: 12/738,535

(22) PCT Filed: Oct. 16, 2008
(86) PCT No.: PCT/GR08/00062

§ 371 Date: Apr. 16, 2010

(30) Foreign Application Priority Data
Oct. 18, 2007 (GR) 20070100637

(51) Int. Cl. A62C 31/00

(52) U.S. Cl. 169/53

(57) ABSTRACT

The RAINSTORM Method applies to helicopters having suspended or built-in liquid reservoir. The innovation lies on the transformation of the fire fighting liquid into artificial rain in the form of an umbrella having diameter approximately equal to the diameter of the helicopter's propeller, with adjustable density and duration. The rain creation mechanism in both cases consists of a hollow propeller with two wings where the liquid is guided hydraulically. The liquid jets through nozzles which are in counterpoised arrangement causing the initial revolution of the hollow propeller. This rotation is accelerated and stabilized from the downstream of the helicopter's propeller. The suspended reservoir is adapted by means of a triangular arrangement with three belts through a rectangular stretcher fixed on the helicopter's hook. The built-in reservoir uses a retractable or inclined metallic pipe at the free end of which a hollow propeller is adapted through a free rotation mechanism.

### CROSS-REFERENCE TO RELATED APPLICATIONS

This application is an U.S. national phase application under 35 U.S.C. §371 based upon co-pending International Application No. PCT/GR2008/000062 filed on Oct. 16, 2008. Additionally, this U.S. national phase application claims the benefit of priority of co-pending International Application No. PCT/GR2008/000062 filed on Oct. 16, 2008, and Greece Application No. 20070100637 filed on Oct. 18, 2007. The entire disclosures of the prior applications are incorporated herein by reference. The international application was published on Apr. 23, 2009 under Publication No. WO 2009/050524 A1.

### BACKGROUND OF THE INVENTION

1. Field of the Invention

The purpose of the present invention, which henceforth will be mentioned for brevity as the RAINSTORM Method, is to create, by means of fire fighting helicopters, conditions of an artificial heavy rainstorm equivalent to a real rainstorm, which one would have wished to break out in reality during the fire.

The technical implementation field of the RAINSTORM Method is the fire fighting even in locations where firefighting helicopters can not, or are not permitted to operate, i.e. the fringes of inhabited areas, isolated residencies in tree lines, areas with High Voltage transportation pylons, areas with trapped vehicles, people, animals, farming installations, areas where Land Forces operate and in general where there is no risk of damage and loss of life by creating an artificial rain phenomenon of controlled intensity and duration.

The advantages of the RAINSTORM method allow preventive spraying or decontaminations eve during the night.

2. Description of the Prior Art

Present Day Situation: Two types of helicopters are used for fire fighting are under use today: Those which carry water inside the fuselage, similar to the equivalent airplanes, and those which use suspended buckets.

In both cases dropping of water takes place in a few seconds with the form of a waterfall and, if we take into consideration, in many cases, the unfavorable conditions of visibility, it is very likely and/or inevitable to miss the target, which is translated in loss of the entire water load as well as in precious time, within which the fire gains ground.

Moreover this way of fire fighting, with great volumes of water falling with high speed to the ground, which cannot be applied in the above mentioned cases, has also the basic disadvantage that only a small percentage of the falling water is used for fire fighting.

Furthermore, during the violent drop of the water, a vacuum is created attracting air with the form of siphon which revives the fire.

It must be mentioned and pointed out that the biggest effectiveness of water, when it is used for fire fighting, is achieved with the uniform rainfall above the fire area under form of droplets, so as these to have the largest surface in order to evaporate very rapidly, absorbing from the fire the biggest amount of heat, decreasing respectively the temperature of the area, which in combination with the rarefaction of oxygen, due to the interjection of water vapors, will contribute in the repression and the extinguishment of Fire in the smallest possible time.

Finally it must also be pointed out that the helicopters, despite their relatively small carrying capacity compared to the Fire fighting airplanes, have two basic and undeniable advantages: Fly with very small speeds—up to hovering speed, as well as to be able to land/descend vertically, in order to be supplied with water and fuel, in relatively very small spaces.

Furthermore, the RAINSTORM method can be used in cases of preventive spraying with water or retarding liquid, as well as for decontamination of large areas.

The safety of the RAINSTORM method allows the aircraft to operate during the night as well, thus giving a unique advantage.

### SUMMARY OF THE INVENTION

In view of the foregoing disadvantages inherent in the known types of helicopter fire fighting systems now present in the prior art, the present invention provides an improved aircraft fire extinguishing system and method, and overcomes the above-mentioned disadvantages and drawbacks of the prior art. As such, the general purpose of the present invention, which will be described subsequently in greater detail, is to provide a new and improved aircraft fire extinguishing system and method and method which has all the advantages of the prior art mentioned heretofore and many novel features that result in a aircraft fire extinguishing system and method which is not anticipated, rendered obvious, suggested, or even implied by the prior art, either alone or in any combination thereof.

Fire fighting by means of the RAINSTORM Method.

The RAINSTORM method was devised, studied and engineered in such a way in order to avoid all disadvantages and weaknesses that we face today during fire fighting with helicopters, and at the same time to exploit in the biggest possible degree the particular abilities of helicopters, as well as, and the fire fighting capabilities of water.

The Key for confronting the above mentioned disadvantages in the present situation, as well as the combined exploitation of helicopter and water capabilities in fire fighting, in order to obtain the biggest fire fighting Result, constitutes.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a side plane view of an embodiment of the aircraft fire extinguishing system constructed in accordance with the principles of the present invention, with the phantom lines depicting environmental structure and forming no part of the claimed invention.

FIG. 2 is a top elevational view of the aircraft fire extinguishing system of the present invention.

FIG. 3 is a rear plane view of the aircraft fire extinguishing system of the present invention.

FIG. 4 is a cross-sectional view of the aircraft fire extinguishing system of the present invention taken along the line 4-4 in FIG. 3.

FIG. 5 is a cross-sectional view of the aircraft fire extinguishing system of the present invention taken along line 5-5 in FIG. 4.

FIGS. 6A-C is an in use illustrative view of the aircraft fire extinguishing system and method of the present invention.

FIG. 7 is a top elevational view of a reservoir suspension device of the aircraft fire extinguishing system of the present invention.

FIG. 8 is a cross-sectional view of the reservoir suspension device taken along line 8-8 in FIG. 7.

FIG. 9 is an in use illustrative view of an alternate embodiment aircraft fire extinguishing system and method of the present invention.

FIG. 10 is a side plane view of an alternate embodiment of the aircraft fire extinguishing system of the present invention.

FIG. 11 is a top elevational view of the alternate embodiment aircraft fire extinguishing system of the present invention.

The same reference numerals refer to the same parts throughout the various figures.

### DESCRIPTION OF THE PREFERRED EMBODIMENT

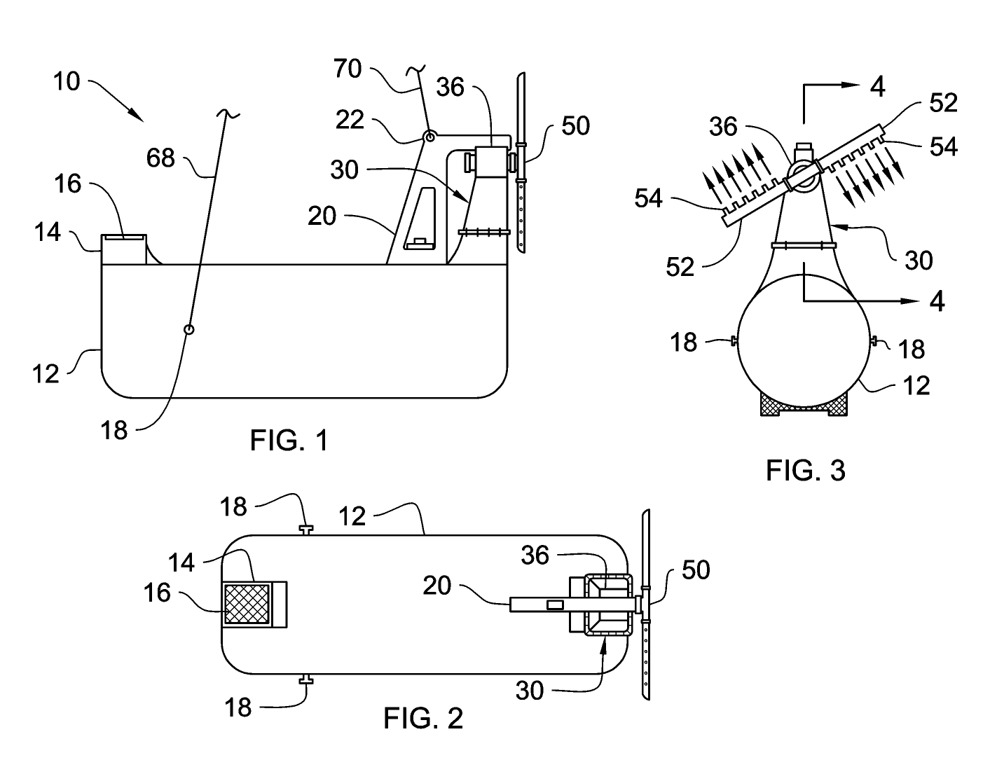

Referring now to the drawings, and particularly to FIGS. 1-11, an embodiment of the aircraft fire extinguishing system and method of the present invention is shown and generally designated by the reference numeral 10.

The Water Reservoir with the Artificial Rain Creation Mechanism

It is a cylindrical reservoir 12, in the rear side of which the artificial rain creation and dousing mechanism is adapted. The Schematic Diagrams of the Reservoir and the artificial rain creation mechanism 30 are shown in FIGS. 1-5.

The dimensions of the reservoir 12 and its capacity are standardized in sizes respectively with the lifting capability of helicopters used for fire fighting.

The reservoirs 12 are suspended from the helicopters 60 by means of three wire ropes—belts 68, 70, which are fixed, with couplers easy to dismantle, in three points of the reservoir 18, 22, in triangular arrangement, two coupling points 18 on the sides of reservoir 12 and the third 22 in its rear side.

The suspended reservoir 12 has two main components connected to each other with a watertight flange 34, as follows:
The Water Reservoir Unit 10 which is a cylindrical reservoir 12, manufactured from material durable in marine water, having a powerful frame in order to withstand all load strains and vibrations caused by the various helicopter maneuvers especially during the dousing phase.

In the upper front compartment of the reservoir there is a specifically shaped and elevated intake orifice 14 used for the replenishment of the reservoir 12 with water, which, if required, opens and closes automatically during the three phases of operation of the reservoir 12, i.e.: Water filling (Open), Transportation of water (Closed) and fire fighting (Open).

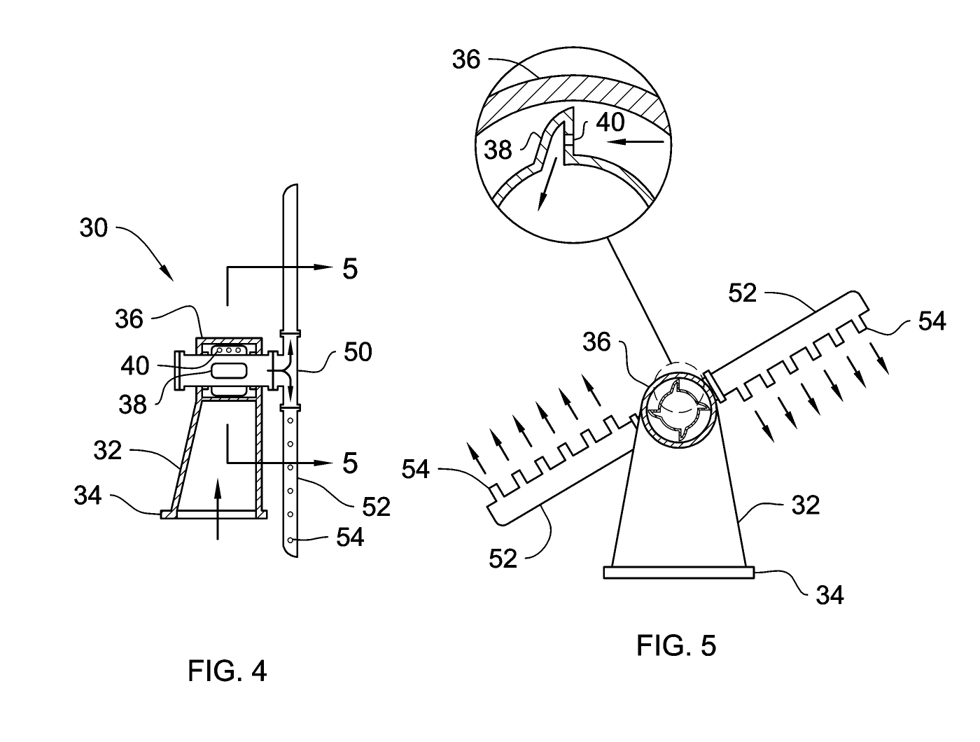

The caudal reinforcing fin 20 is fixed in the upper rear side of the reservoir 12. This fin 20 retains the rain creation mechanism 30 from above, in the top of which exists the third point of suspension 22.
The Rain Creation/Dousing Unit 30, manufactured from stainless material, which includes:
The Conical Pipe 32 which channels the water to the Hydraulic Mechanism 36.
The Hydraulic Mechanism-Water Turbine 36 of the propeller 50, as best illustrated in FIGS. 4 and 5 which is fitted with the bladed trunnion 38 with ports 40 for channeling the pressurized water to the rain creation mechanism (propeller) 50, and
The Rain Creation Mechanism 50, which consists of the hollow propeller 52, that is water tightly connected to the trunnion 38 of the Hydraulic Mechanism-Water Turbine 36. The hollow propeller 52 has sufficient number of nozzles 54 in each blade having the appropriate diameter, in order that in correlation with the speed and the flight height of the helicopter 60, the desired diameter and density of the rain droplets in the umbrella 66 that will take shape in the dousing phase will be achieved, thus ensuring, after experimenting, the biggest fire fighting result (Creation of Tables).

Note: The direction of water centrifugation can be combined with the helicopter propeller in order to obtain a better interaction.

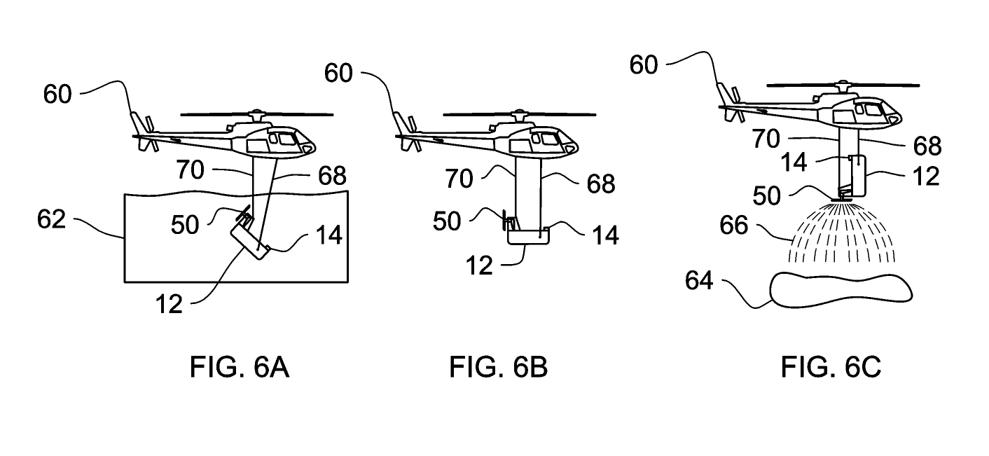

The fire fighting process with the RAINSTORM Method includes the following stages, as best illustrated in FIGS. 6A-6C:
Filling up of the Reservoir with Water (FIG. 6A). This is achieved with the following ways:
From the Sea, Lakes and rivers, as the current practice.
From man made Reservoirs of large capacity, having a depth of at least 2.5 m, which either exist or will be constructed near specifically protected areas as: archaeological sites, open air theaters, zoos, gardens, mountains etc.
In the above two cases the helicopter 60 is flown over the supply source 62 and with the help of a winch, operated from within the helicopter 60, the third wire rope 70 which is hooked to the caudal fin 20 is set into operation, lifting thus the tail of the reservoir 12 until its longitudinal axis reaches an angle of approx. 45° to the water leve. The helicopter 60 is then lowered progressively and the reservoir 12 sinks under its own weight, and starts to fill up from the wide orifice 14 located at the elevated front end. As soon as the replenishment of the reservoir 12 is completed within a few seconds the caudal wire rope 70 is lifted, the reservoir 12 assumes the horizontal position, as best illustrated in FIG. 6B, the helicopter 60 is lifted and flies to the fire 64.
In addition to the above mentioned methods, the RAINSTORM Program gives the possibility to transport backup reservoirs 12 near the fire 64, placing them in open areas (stadiums, fields etc.). These backup reservoirs 12 will be filled up by water tank vehicles of the local authorities and/or private individuals. In this way the helicopters will leave the empty reservoirs for replenishment and pick up in minimum time the filled ones in order to return very rapidly to the fire, thus multiplying the fire fighting force of the helicopters. This is equivalent to a bigger helicopter fleet.
Flying to the Scene of Fire. During this phase, the reservoir 12 is at the horizontal position, as best illustrated in FIG. 6B, in order not to waste any water during transportation from the filling orifice 14, which is also equipped with a non return mechanism 16, as well from the rain creating mechanism 30 which is located over the highest water level of the reservoir 12.
Rain Creation and Fire Fighting. As soon as the helicopter 60 approaches the scene of fire 64 and assumes the proper flight height, the caudal wire rope 70 is slackened until the reservoir 12 assumes the vertical position and the rain creating mechanism 50 is horizontal, as best illustrated in FIG. 6C.

In this position, under the pressure of the, above water column, the Hydraulic Mechanism Water Turbine 30 is set into automatic operation simultaneously setting the propeller 52 into rotation, while at the same time the incoming water is channeled towards the counterbalancing nozzles 54 and dashes out through them with great momentum intensifying the propellers rotation, and contributing thus in the better centrifugation of water and in the enlargement of shaped rain umbrella 66.

Note: The relative experiments will show which is the optimum number of nozzles, their diameter as well as the reservoir water drop duration, so that in function with the flight level and the helicopters speed, to achieve maximum firefighting results in the ground. Fire Fighting Helicopter Method of Operation

In order to have the best possible results in fire fighting with the RAINSTORM Method, the helicopters must operate in a Systematic Manner, depending on the pattern, the extend and the intensity of the fire.

The way of operation will be decided each time by the responsible person in charge of the Command and Control Center, according to the relative information reported.

As an example, when the front of the fire is relatively narrow, then the helicopters (2 or 3) will attempt one behind the other, maintaining a safety distance, and will fly in a row above the fire front. If however the width of fire front is relatively wide, then the helicopters will fly in shapes, in such a way that the rain umbrellas will cover the whole rain front, Le. in triangular arrangement with one helicopter in front and two behind, or two helicopters in front and three behind and so on.

What has particular importance and must be enforced during all the air missions is the detailed coordination in order to achieve best results with minimum cost. This of course must not go against all security measures, which must at any rate be applied in order to minimize possible disasters and loss of life.

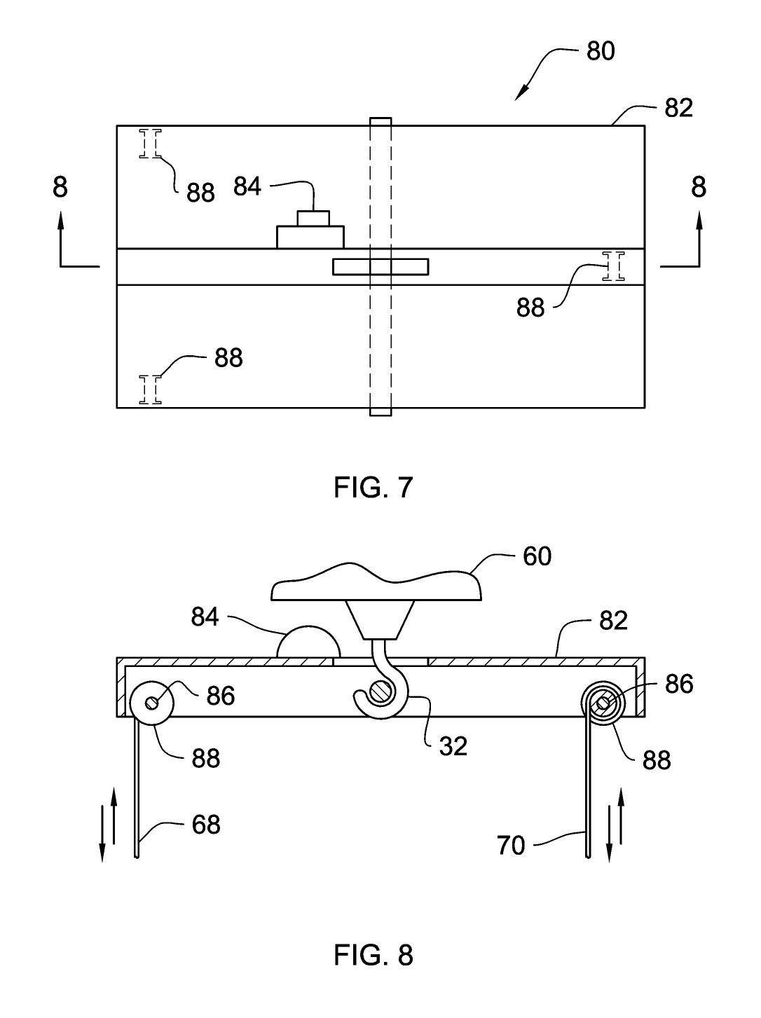

As best illustrated in FIGS. 7 and 8, a reservoir suspension device 80 can be used to suspend and control the angle of the cylindrical reservoir from the aircraft 60. The reservoir suspension device 80 consists of a rectangular shaped frame or stretcher 82 which is removably connected to a hook 61 of the aircraft 60. The stretcher 82 has a general dimension of, but not limited to, 2.00 m (length)×1.00 m (width)×0.20 m (height). The purpose of the stretcher 82 is to strap the three (3) belts 68, 70 from which the cylindrical reservoir is suspended in a triangular arrangement.

The stretcher 82 is fitted with a 12V servomechanism or winch 84, powered from within the aircraft 60. The servomechanism 84 is operated by means of a simple controller located in the aircraft's 60 cockpit.

The servomechanism 84 moves two parallel shafts 86 located on each side of the stretcher 82. One shaft includes drums 88 located at each end thereof with belts 68 wound therearound, and the other shaft includes one drum 88 with belt 70 wound therearound. The belts 68, 70 have a free end of approximately, but not limited to, 70-80 cm. At the end of each belt 68, 70 is included a fast coupler which connects the stretcher 82 with the cylindrical reservoir. The belts 68, 70 have an approximate length of, but not limited to, 10-12 m.

This arrangement allows the rotation of the drums 88 of the stretcher 82 by means of approximately three (3) rotations of the servomechanism 84. This elevates and descends the belts 68, 70 approximately, but not limited to, 70-80 cm, thereby tilting the longitudinal axis of the cylindrical reservoir ±45°, without shifting its center of gravity.

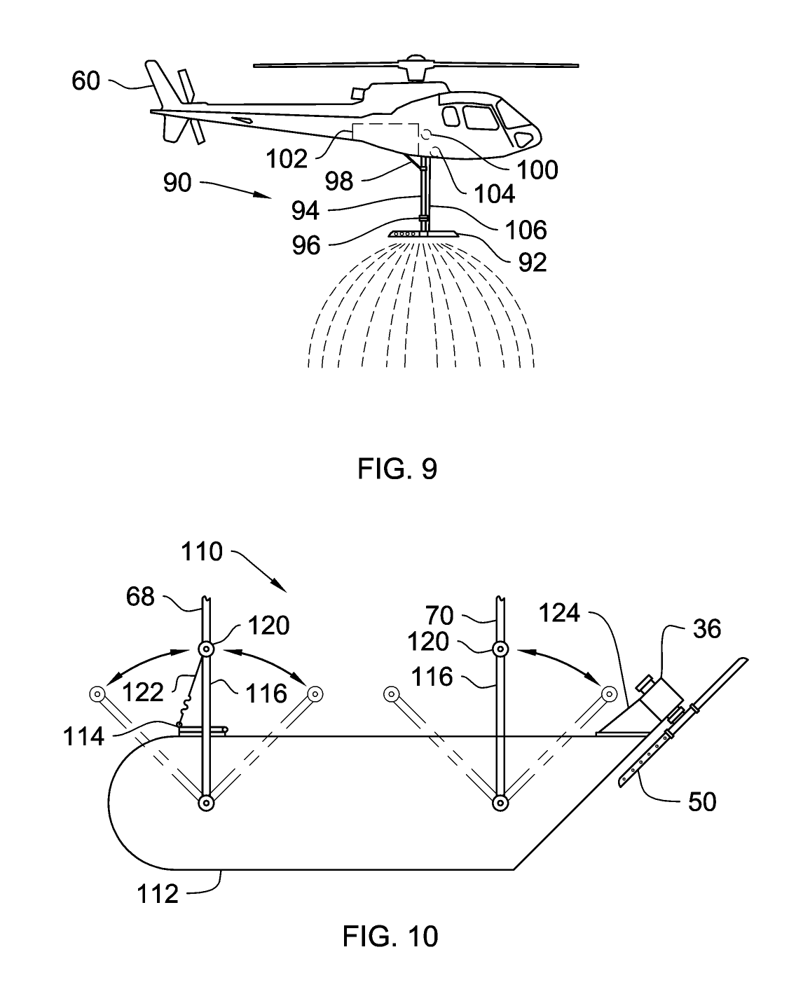

As best illustrated in FIG. 9, the present invention can also be adapted to be used with aircrafts or helicopters 60 having a built-in liquid reservoir 100. A rain creation mechanism and dousing unit 90 includes rotating hollow propellers 92 for the centrifugation of water. The rain creation mechanism and dousing unit 90 has an immediate implementation with heavy fire fighting helicopters or aircrafts that posses a built-in liquid reservoir with a capacity, such as but not limited to, 3-15 m³. In these cases only common industrial equipment can be used.

The rain creation mechanism and dousing unit 90 further includes a reclined or retractable telescopic pipe 94 having a total length of approximately, but not limited to, 3.00 m. The pipe 94 is adapted to and in fluid communication with the helicopter's 60 reservoir, and at the end of which is fitted the hollow propellers 92 through a free rotating mechanism 96 that is in a substantially vertical position to the pipe 94.

The rain creation mechanism and dousing unit 90 can be raised and lowered into position be a hydraulic mechanism 98.

A water pump 100 is used to pump water or liquid from the built-in reservoir 102 to a first element of the telescopic pipe 94, thus protracting the pipe and setting the hollow propellers 92 into rotation. This rotation is accelerated by the downstream air of the helicopter's rotors.

A 12V servomechanism or winch 104 is fitted to the helicopter's floor. A cable 106 connected and operated by the servomechanism 104 is connected to the end of the pipe 94. The cable 106 follows the movement of the pipe 94 during the extension phase, and retracts the pipe once the operation is complete.

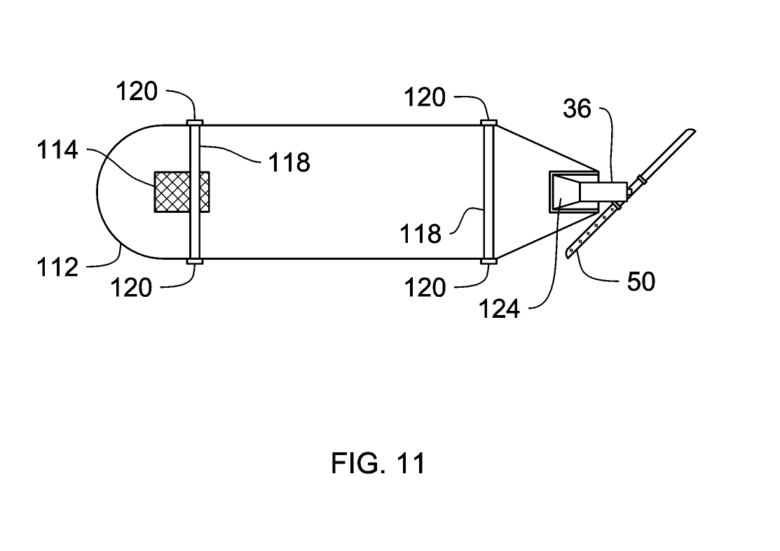

FIGS. 10 and 11 best illustrates an alternate embodiment water reservoir and artificial rain creation mechanism 110. This embodiment includes a cylindrical reservoir 112 having an artificial rain creation and dousing mechanism located on a rear side thereof.

The dimensions of the reservoir 112 and its capacity are standardized in sizes respectively with the lifting capability of helicopters used for fire fighting.

The reservoir 112 includes two pivoting suspension assemblies located adjacent to each end of the reservoir 112. Each suspension assembly includes a pair of pivoting suspension arms 116 located on opposite sides of the reservoir 112. Each pair of suspensions arms 116 include a cross arm 118 connected to the free ends of the suspension arms, as best illustrated in FIG. 11.

One pair of suspension arms 116 are located at a front end of the reservoir and include a coupling point 120 located at the free ends of each suspension arm. The other pair of suspension arms 116 includes a single coupling point 120 centrally located on said coupling arm 118.

The reservoir 112 is suspended from the helicopters by means of three wire ropes or belts 68, 70, which are fixed with couplers to a corresponding coupling point 120, thereby forming a triangular arrangement.

The reservoir 112 is manufactured from material durable in marine water, having a powerful frame in order to withstand all load strains and vibrations caused by the various helicopter maneuvers especially during the dousing phase. The rear end of the reservoir 112 is a angled planar surface with an angle of approximately 45°.

In an upper front compartment of the reservoir 112 there is a specifically shaped and elevated intake orifice featuring a valve 114 used for the replenishment of the reservoir 112 with water. The valve 114 opens and closes automatically during the three phases of operation of the reservoir 112 by way of a spring or line 122 connected to the cross arm 118 of the front end located suspension arms 116. Thus, when the front end suspension arms 116 are pivoted in one direction, the spring 122 is pulled thereby opening the valve 114.

The water reservoir and artificial rain creation mechanism 110 further includes a rain creation and dousing unit, manufactured from stainless material. The rain creation and dousing unit includes an angled conical pipe 124 which channels the water to a hydraulic mechanism and water turbine 36, and a hollow propeller assembly 50. The pipe 124 is parallel with the angle of the rear end of the reservoir 112.

The hydraulic mechanism and water turbine 36 is fitted with the ported bladed trunnion for channeling the pressurized water to the hollow propeller assembly 50. The hollow propeller assembly 50 includes a plurality of propellers each with multiple nozzles each having an appropriate diameter to form a rain umbrella that will take shape in the dousing phase. The hollow propeller assembly 50 is watertightly connected and in fluid communication with the hydraulic mechanism and water turbine 36, and is angle so as to be parallel with the angle of the rear end of the reservoir 112.

1-3. (canceled)

4. An artificial rain system for firefighting by aircrafts, said artificial rain system comprising:
a reservoir having a front end and a rear end, said reservoir being configured to retain fluid therein; and
a dousing unit fitted to and in fluid communication with said reservoir, said dousing unit comprising:
a conical pipe watertightly fitted to an upper rear end of said reservoir;
a hollow turbine shaft in fluid communication with said conical pipe and rotatably mountable to said dousing unit;
and a hollow propeller assembly watertightly and perpendicularly connectable to said turbine shaft;
wherein said turbine shaft carrying at least one bladed trunnion defining at least one port for centrifuging said fluid from said reservoir into said hollow propeller assembly through said hollow turbine shaft;
wherein said hollow propeller assembly having at least one hollow blade in fluid communication with said hollow turbine shaft, said hollow blade having at leas one nozzle for dispensing said fluid.

5. The artificial rain system according to claim 4 further comprising a motor attachable to and for rotatably driving said turbine shaft.

6. The artificial rain system according to claim 4, wherein said reservoir is a cylindrical reservoir having an indicative length sufficient to ensure the necessary hydrostatic pressure to rotate said turbine shaft when said cylindrical reservoir is in a substantially vertical position.

7. The artificial rain system according to claim 6, wherein said cylindrical reservoir having an indicative length of 2.40 m.

8. The artificial rain system according to claim 4, wherein said hollow blade of said hollow propeller assembly being at least two replaceable wings each including said nozzle, said nozzles each being configured to dispense said fluid centrifuged from said turbine shaft.

9. The artificial rain system according to claim 4, wherein said reservoir further comprising at least one elevated intake orifice located on said upper end opposite said dousing unit.

10. The artificial rain system according to claim 9, wherein said elevated intake orifice further comprising a valve.

11. The artificial rain system according to claim 4 further comprising at least one caudal fin attached to said upper side of said reservoir and said dousing unit.

12. The artificial rain system according to claim 11 further comprising at least three lines including couplers, wherein said reservoir further comprising at least two coupling points each being attachable to at least two of said couplers of said lines, and said caudal fin further comprising at least on coupling point attachable to at least one of said couplers of said lines, wherein said lines being attachable to an aircraft thereby suspending said artificial rain system from said aircraft.

13. The artificial rain system according to claim 12, wherein said line attachable to said coupling point of said caudal fin is connected to a winch in said aircraft.

14. The artificial rain system according to claim 12, wherein said lines attachable to said coupling points of said reservoir are connected to a winch in said aircraft.

15. An aircraft artificial rain system comprising:
a cylindrical reservoir having a front end, a rear end, and at least two coupling points located on opposite sides of said cylindrical reservoir for each connecting to a coupler of a line, said cylindrical reservoir being configured to retain fluid therein;
a dousing unit fitted to and in fluid communication with said cylindrical reservoir, said dousing unit comprising:
a conical pipe watertightly fitted to an upper rear end of said cylindrical reservoir;
a hollow turbine shaft in fluid communication with said conical pipe and rotatably mountable to said dousing unit; and
a hollow propeller assembly watertightly and perpendicularly connectable to said turbine shaft;
wherein said turbine shaft carrying at least one bladed trunnion defining at least one port for centrifuging said fluid from said cylindrical reservoir into said hollow propeller assembly through said hollow turbine shaft;
wherein said hollow propeller assembly having at least one hollow blade in fluid communication with said hollow turbine shaft for dispensing said fluid out therefrom; and
at least one caudal fin attached to said upper side of said cylindrical reservoir and an upper side of said dousing unit, said caudal fin having at least one coupling point for connecting to a coupler of a line.

16. The artificial rain system according to claim 15, wherein said cylindrical reservoir having an indicative length sufficient to ensure the necessary hydrostatic pressure to rotate said turbine shaft when said cylindrical reservoir is in a substantially vertical position.

17. The artificial rain system according to claim 15, wherein said hollow blade of said hollow propeller assembly being at least two replaceable wings each including at least one nozzle, said nozzles each being configured to dispense said fluid centrifuged from said turbine shaft.

18. The artificial rain system according to claim 15, wherein said cylindrical reservoir further comprising at least one elevated intake orifice located on said upper end opposite said dousing unit, said elevated intake orifice further comprising a valve.

19. The artificial rain system according to claim 15 further comprising a reservoir suspension assembly having a substantially rectangular frame attachable to an aircraft, a servomechanism that drives at least two parallel shafts in opposite directions, at least two drums attachable to one of said shafts, and at least one drum attachable to said other shaft, wherein said drums are connectable to said lines.

20. A method of using an artificial rain system for firefighting with aircrafts by means of fluid transformation to artificial rain using, said method comprising the steps of:
a) providing an artificial rain system comprising: a reservoir; and a dousing unit fitted to and in fluid communication with said reservoir;
b) transporting said reservoir to a fluid source;
c) filling said reservoir with a fluid from said fluid source;
d) transporting said reservoir and said dousing unit to a desired location by way of an aircraft; and
e) allowing said fluid to flow through said dousing unit to a hollow propeller assembly connected and in fluid communication thereto, then through hollow blades of said hollow propeller assembly, and then exiting through nozzles of said hollow blades.

21. The method according to claim 20, wherein said reservoir is built-in to said aircraft, and wherein said fluid is allowed to flow in step e) using a pump which pumps said fluid from said reservoir to said dosing unit through a pipe.

22. The method according to claim 20 further comprising the steps of, after step b):
f) suspending said reservoir from said aircraft by a three point triangular arrangement;
g) inclining said reservoir to at least 45° in relation to said fluid source;
h) opening a valve located in an intake orifice located in an upper side of said reservoir, and immersing said reservoir in said fluid source; and
i) inclining said reservoir to a substantially horizontal position parallel with a longitudinal axis of said reservoir, and closing said valve.

23. The method according to claim 22 further comprising the steps of, after step d):
k) inclining said reservoir to a substantially perpendicular position in relation to said position in step i); and
wherein said fluid is allowed to flow in step e) by opening said valve in said intake orifice thereby allowing said fluid to flow through a conical pipe of said dousing unit, to a hollow turbine shaft for rotating said hollow turbine shaft via bladed trunnions, then through defined ports of said bladed trunnions for centrifuging said fluid from said reservoir into said hollow propeller assembly connected to said hollow turbine shaft, then through said hollow blades of said hollow propeller assembly, and then exiting through said nozzles of said hollow blades.
